(19) United States
(12) Patent Application Publication
(10) Pub. No.: US 2013/0098272 A1
(43) Pub. Date: Apr. 25, 2013

(54) METHOD AND COMPOSITIONS FOR POZZOLANIC BINDERS DERIVED FROM NON-FERROUS SMELTER SLAGS

(71) Applicant: Flyanic, LLC, Auburn, NY (US)

(72) Inventors: Raymond T. HEMMINGS, Kennesaw, GA (US); Bruce J. Cornelius, Waterdown (CA)

(73) Assignee: Flyanic, LLC, Auburn, NY (US)

(21) Appl. No.: 13/657,426

(22) Filed: Oct. 22, 2012

Related U.S. Application Data
(60) Provisional application No. 61/549,459, filed on Oct. 20, 2011.
(60) Provisional application No. 61/565,690, filed on Dec. 1, 2011.
(60) Provisional application No. 61/625,753, filed on Apr. 18, 2012.

(51) Int. Cl. C04B 18/14

(52) U.S. Cl. CPC C04B 18/141
USPC 106/790; 106/819; 106/789

(57) ABSTRACT

The invention encompasses an ultrafine NFS powder wherein the particle size is sufficiently small as to increase the proportion of the reactive glassy silicate phase in the NFS, methods of making the ultrafine NFS powder, and cementitious products which use the ultrafine NFS powder. The invention also encompasses pozzolanic binders produced by fine grinding non-ferrous smelter slags, as well as methods for processing the non-ferrous slags wherein various chemical additives, such as pH increasing additives, are added to the binders to increase the strength of compositions for uses such as mine backfill or grout mixtures.

### CROSS REFERENCE TO RELATED APPLICATIONS

This application claims the benefit of U.S. Provisional Application No. 61/549,459 filed on Oct. 20, 2011; U.S. Provisional Application No. 61/565,690, filed on Dec. 1, 2011; and U.S. Provisional Application No. 61/625,753, filed on Apr. 18, 2012, hereby incorporated by reference in their entirety.

### FIELD OF THE INVENTION

The present invention encompasses pozzolanic cementitious binders for use in consolidated mine backfill and other applications in the construction industry. More specifically the invention encompasses pozzolanic binders produced by fine grinding non-ferrous smelter slags, as well as methods for processing the non-ferrous slags and their use. Various chemical additives, such as pH increasing additives, may be added to the binders to increase the strength of compositions for uses such as mine backfill or grout mixtures.

### BACKGROUND OF THE INVENTION

Cementitious binders are used to consolidate backfill material used for structural fill in mined-out stopes in underground hard-rock mining operations. The aggregate component of the backfill is typically graded sand that is recovered from flotation tailings, local quarried alluvial sand, or overburden recovered from site preparation. A single mine can consume more than 100,000 tons per year of cementitious binder for backfilling operations.

Non-ferrous metals smelters produce large quantities (hundreds of thousands of tons) of siliceous or ferro-siliceous slag, which is currently a waste product. This waste product requires disposal which may be at significant cost, both in terms of monetary costs as well as the associated potential environmental impact. Examples of such non-ferrous metals smelters include, but are not limited to, those for production of nickel, copper, lead, and zinc, as well as other non-ferrous metals.

The smelter slags may contain various proportions of non-crystalline (glassy) silicates or ferro-silicates depending on the thermal history. The glassy components are the main reactive constituent of the slags.

### SUMMARY OF THE INVENTION

In one embodiment, the invention encompasses an ultrafine non-ferrous slag (herein termed “NFS”) powder wherein the particle size is sufficiently small as to increase the exposed surface area of the reactive glassy silicate phase in the NFS.

In another embodiment, the method of the invention encompasses a process comprising: (1) pretreating NFS from a smelter into a coarse sand consistency to obtain a pre-processed NFS; (2) ultrafine grinding of the pre-processed NFS to obtain an ultrafine NFS powder; and (3) blending the ultrafine NFS powder with a cement to obtain a cementitious product.

In one embodiment, the invention encompasses an ultrafine non-ferrous slag (NFS) powder having non-ferrous slag with a median particle size of about 3 μm to about 15 μm, wherein the particle size is sufficiently small to increase the proportion of the reactive glassy silicate phase in the non-ferrous slag. In another embodiment, the median particle size is about 5 μm to about 12 μm. In one embodiment, the ultrafine non-ferrous slag powder has a glassy silicate phase having a SiO₂ surface area increase of 40% to 70% as compared to the bulk NFS that has not been pulverized to the median particle size of about 3 μm to about 15 μm. In another embodiment, the ultrafine non-ferrous slag powder has a glassy silicate phase having a sulfur surface area increase of 180% to 270% as compared to the bulk NFS that has not been pulverized to the median particle size of about 3 μm to about 15 μm. In yet another embodiment, the ultrafine non-ferrous slag powder has a glassy silicate phase having SiO₂ in an amount of about 25% to about 70% by weight of the glassy silicate as determined by the surface area. In another embodiment, the ultrafine non-ferrous slag powder has a glassy silicate phase having sulfur in an amount of about 0.5% to about 5% by weight of the glassy silicate as determined by the surface area. In yet another embodiment, the ultrafine non-ferrous slag powder has a composition of about 65% to about 70% by weight of fayalite, about 5% magnetite, and about 25-30% by weight of glass.

One embodiment of the invention encompasses a cementitious composition comprising an ultrafine NFS powder having non-ferrous slag with a median particle size of about 3 μm to about 15 μm, wherein the particle size is sufficiently small to increase the proportion of the reactive glassy silicate phase in the non-ferrous slag and at least one cement. In another embodiment, the cementitious composition has a weight ratio of ultrafine NFS powder to cement of about 90:10 to 50:50. In yet another embodiment, the cementitious composition has a compressive strength of about 3000 psi to about 4500 psi after 7 days of curing as determined by ASTM C618 protocol. In another embodiment, the cementitious composition has a pozzolanic activity index of about 70% to about 85% relative a control having no ultrafine NFS powder after 7 days of curing. In yet another embodiment, the cementitious compositions further has at least one of cement accelerators, water-reducing agents, binders, or pH increasing compounds. In yet another embodiment, the pH increasing compound is anhydrous sodium carbonate, hydrated sodium carbonate, sodium bicarbonate, sodium hydroxide, sodium metasilicate, anhydrous potassium carbonate, hydrated potassium carbonate, potassium bicarbonate, potassium hydroxide, potassium metasilicate, calcium oxide, or calcium hydroxide. The pH increasing compound may be present in an amount of about 1% to about 10% by weight of the binder.

Another embodiment of the invention encompasses a process for making an ultrafine non-ferrous slag (NFS) powder comprising: (1) pretreating bulk NFS from a smelter into a coarse sand consistency to obtain a pre-processed NFS; and (2) ultrafine grinding of the pre-processed NFS to obtain an ultrafine NFS powder of a determined particle size, wherein the particle size is sufficiently small to increase the proportion of the reactive glassy silicate phase in the NFS. In another embodiment, the ultrafine non-ferrous slag powder has a median particle size of about 3 μm to about 15 μm. In yet another embodiment of the process, the ultrafine non-ferrous slag powder has a median particle size of about 5 μm to about 12 μm. In one embodiment of the process, the ultrafine non-ferrous slag powder has a glassy silicate phase having SiO₂ with a surface area increase of 40% to 70% as compared to the bulk NFS. In yet another embodiment of the process, the ultrafine non-ferrous slag powder has a glassy silicate phase having sulfur with a surface area increase of 180% to 270% as compared to the bulk NFS.

### BRIEF DESCRIPTION OF THE DRAWINGS

FIGS. 1A-B illustrate processing equipment that can be used in the method of the invention for a pilot scale.

FIGS. 2A-B illustrate processing equipment that can be used in the method of the invention for a production scale.

FIG. 3 illustrates a chemical composition for a sample of air-cooled NFS. The approximate composition of the sample is 65-70% fayalite (Fe₂SiO₄); about 5% magnetite (Fe₃O₄); 25-30% glass (SiO₂+Al₂O₃+Fe₂O₃), wherein the percentages are by weight.

FIGS. 4A-C illustrate the particle size distribution of the product obtained from air-cooled NFS as determined by laser interferometer. Each product in the figures has a median particle size (d50%) as illustrated in the figure, together with the following d95(%) values: (4A) NFS-12 12d95 of 25.8 μm; (4B) NFS-6 6d95 of 12.1 μm; and (4C) NFS-3 3d95 of 6.6 μm.

FIGS. 5A-B illustrate the mortar strength of NFS binders (ASTM C618). FIG. 5A illustrates the compressive strength (psi) determined using ASTM C618 as compared to a control (no cement replacement in mortar, i.e., 100% cement). FIG. 5B illustrates the pozzolanic activity index as a percentage of the control for each sample.

FIG. 6 illustrates optical images of granulated NFS and the granule's size.

FIGS. 7A-B illustrate the chemical composition for samples of air-cooled NFS (7A) and granulated NFS (7B).

FIGS. 8A-C illustrate the particle size distribution of the product obtained from granulated NFS. Each product in the figures has a median particle size (d50%) as illustrated in the figure, together with the following d95(%) values: (8A) NFSG-12 12d95 of 37.4 μm; (8B) NFSG-6 6d95 of 23.6 μm; and (8C) NFSG-3 3d95 of 15 μm.

FIGS. 9A-B illustrate the mortar strength of granulated NFS binders. FIG. 9A illustrates the compressive strength as determined using ASTM C618 as compared to a control (no NFSG replacement, i.e., 100% cement). FIG. 9B illustrates the pozzolanic activity index as a percentage of the control for each sample.

FIG. 10 illustrates one strength comparison of air-cooled and granulated NFS samples.

### DETAILED DESCRIPTION OF THE PRESENT INVENTION

The present invention encompasses a variety of pozzolanic cementitious products engineered from non-ferrous smelter slag (NFS) feedstock. These products may also include other components commonly used in the mining industry, the concrete construction industry, as well as other industries that could use the pozzolan products of the invention. The invention also readily allows a variety of potential value added pozzolanic cementitious products to be engineered with tailored finenesses and performance properties from non-ferrous smelter slag feedstock. Not to be limited by theory, however, it is believed that the present invention is based in part on grinding the NFS material to achieve sufficient fineness and exposed surface area to release its latent reactivity. It is significant to note that previous attempts to use NFS as a binder failed to perform this step.

Further, the method encompassed by the invention has low processing costs and uses proven commercially available equipment so it can be readily adapted for use. Also, the binder produced by the process has significantly lower cost than binders currently used for backfill consolidation while providing acceptable strength as determined using ASTM C618. The grinding process is highly efficient and returns 100% of the feed material as product. Production rates and energy consumption parameters vary with the target ultrafine binders (i.e., finely ground NFS). Processability is good. As would be expected, higher energy consumption is required for the finer products, i.e., finer ground NFS requires more energy. The technology provides improved business sustainability through use of waste product.

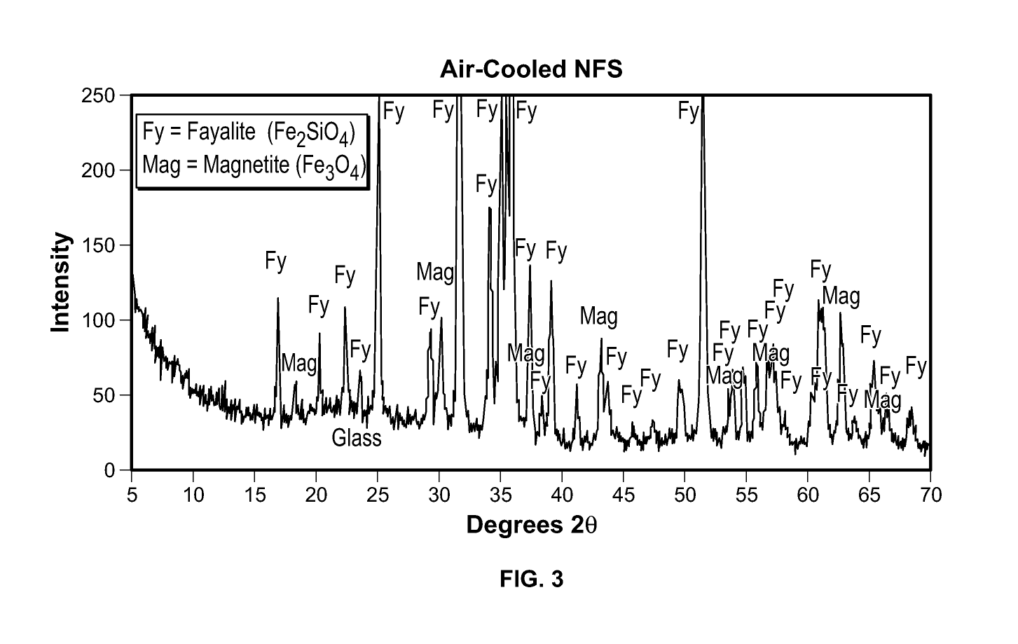

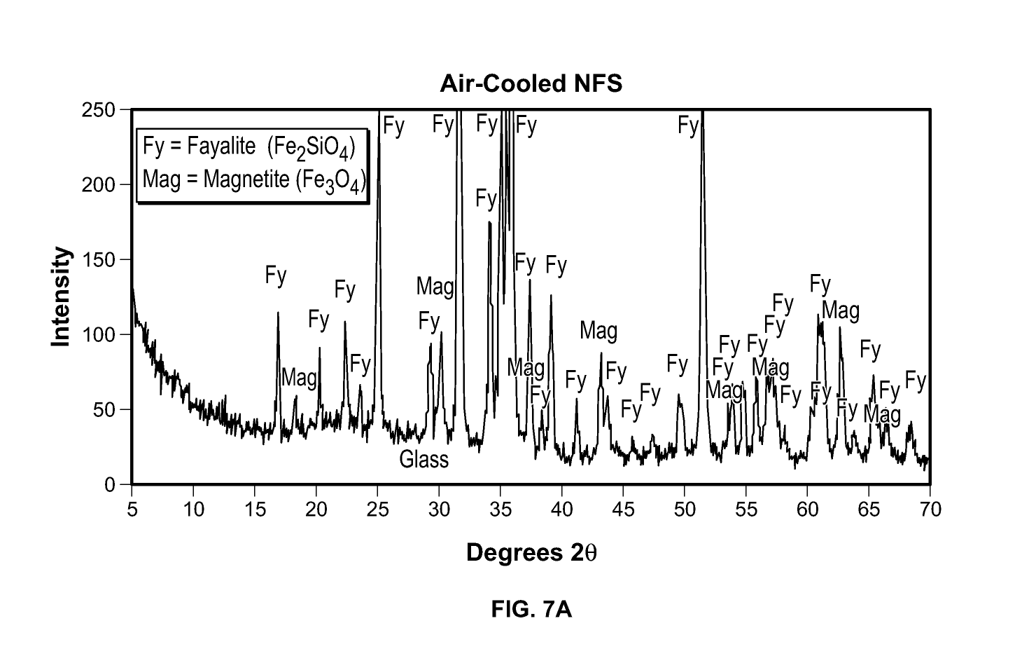

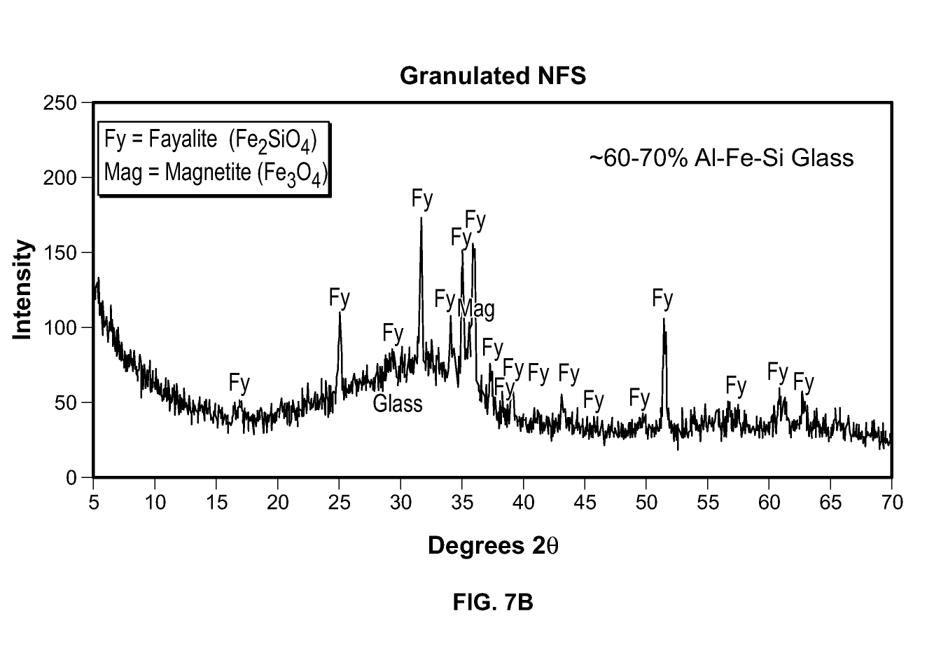

The product of the invention encompasses a finely ground NFS which has enhanced reactivity. Not to be limited by theory, however it is believed that a finely ground NFS increases the exposed surface area of the reactive glassy silicate phase which can cause enhanced reactivity. The increased exposure of glassy silicates and ferro-silicates in the finely ground NFS increases the reactivity and strength of a mortar or cementitious product containing this finely ground NFS. The SiO₂ and sulfur content of the glassy silicates in an air-cooled NFS sample can be estimated by studying the chemical and mineralogical characteristics of the sample. FIG. 3 illustrates such a study, which indicates that the glassy components contain about 37% of SiO₂ and 1% of sulfur as a percentage of glass. After fine grinding this sample, the surface area of the glassy components increases. FIG. 7 illustrates a comparison between the content of an air-cooled NFS sample and a granulated NFS sample. As can be seen in the figure, the SiO₂ content has increased to 57% and the sulfur content in the glassy phase has increased to 3%. As used herein, the term “content” when used in conjunction with glassy phase refers to the amount of exposed surface area. In one embodiment, the glassy components of the ultrafine NFS powder of the invention has about 226% increase in sulfur oxide surface area and/or 53% increase in SiO₂ surface area as compared with bulk NFS material (non-pulverized NFS). Typically, the glassy components of the ultrafine NFS powder of the invention increase in sulfur content (i.e., exposed surface area) from about 180% to about 270%; preferably about 200% to 250%; and more preferably from about 220% to 230% as compared with the bulk NFS material. Typically, the glassy components of the ultrafine NFS powder of the invention increases in SiO₂ content (i.e., exposed surface area) from about 40% to 70%; preferably about 45% to about 65%; and more preferably from about 53% to about 58% as compared with the bulk NFS material.

Thus, one product of the invention is an ultrafine NFS powder wherein the particle size is sufficiently small as to increase the surface area of the reactive glassy silicate phase in the NFS. In other words, one embodiment of the invention is an ultrafine NFS powder with glassy components containing an increased SiO₂ and sulfur content compared with the bulk NFS material.

As used herein, the term “increase” refers to a larger amount of SiO₂ and/or sulfur content (i.e., exposed surface area) found in the exposed glassy components of the finely ground NFS, ultrafine NFS powder, or granulated NFS as compared to the initial product prior to fine grounding or granulation. These values can be estimated using standard semi-quantitative X-ray diffraction techniques commonly known to the skilled artisan such as those illustrated in FIGS. 3 and 7A-B.

The ultrafine NFS powder (also known as finely ground NFS) of the invention contains SiO₂ and/or sulfur content (exposed surface area) greater than the sample prior to grinding. Generally, the ultrafine NFS powder has an approximate composition of 65% to 70% by weight of fayalite (Fe₂SiO₄); about 5% magnetite (Fe₃O₄); and about 25% to 30% by weight glass (SiO₂+Al₂O₃+Fe₂O₃). Typically, the ultrafine NFS powder contains about 25% to about 70% SiO₂ by weight of the glass, preferably about 29% to about 65% SiO₂, and more preferably about 34% to about 60% SiO₂ by weight of the glass. Typically, the ultrafine NFS powder contains about 0.5% to about 5% sulfur by weight of the glass; preferably about 0.8% to about 4%; and more preferably about 1% to about 3.5% by weight of the glass.

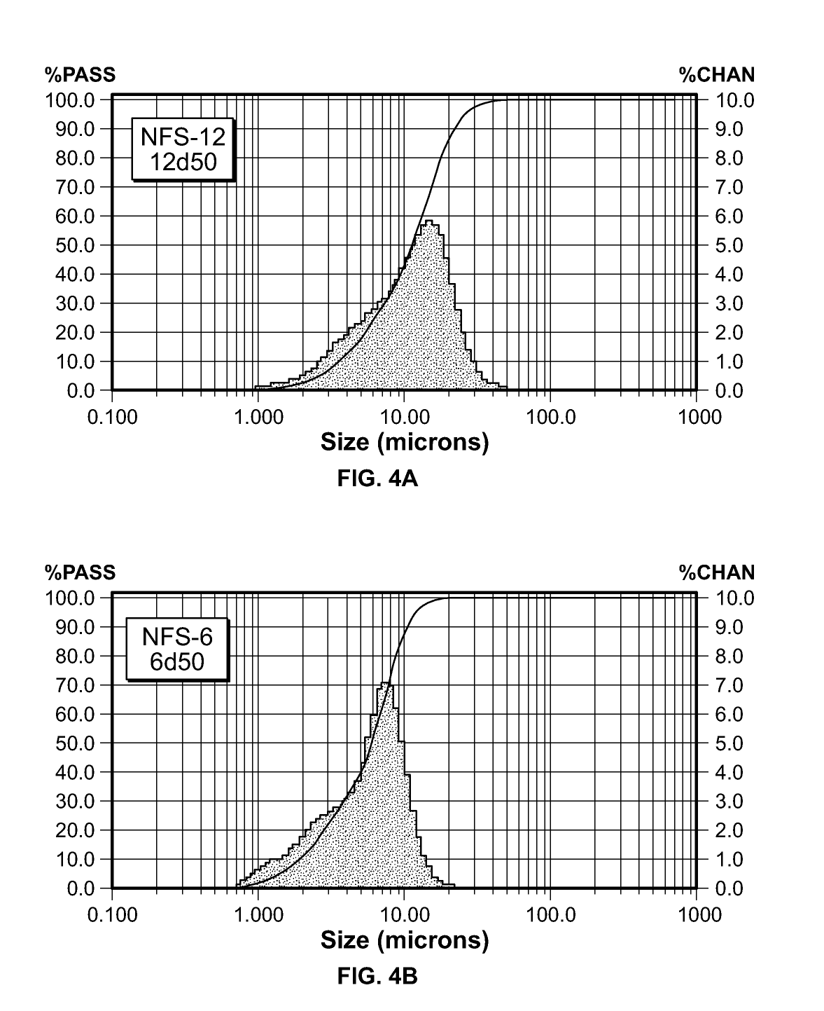

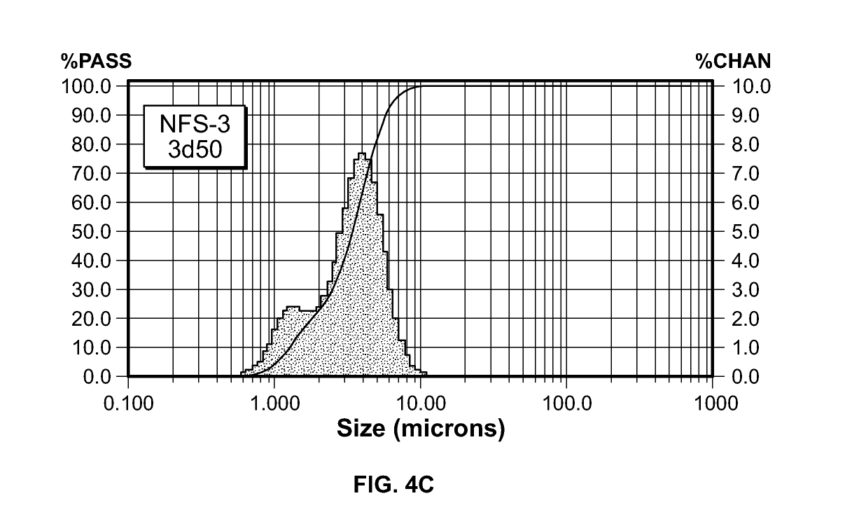

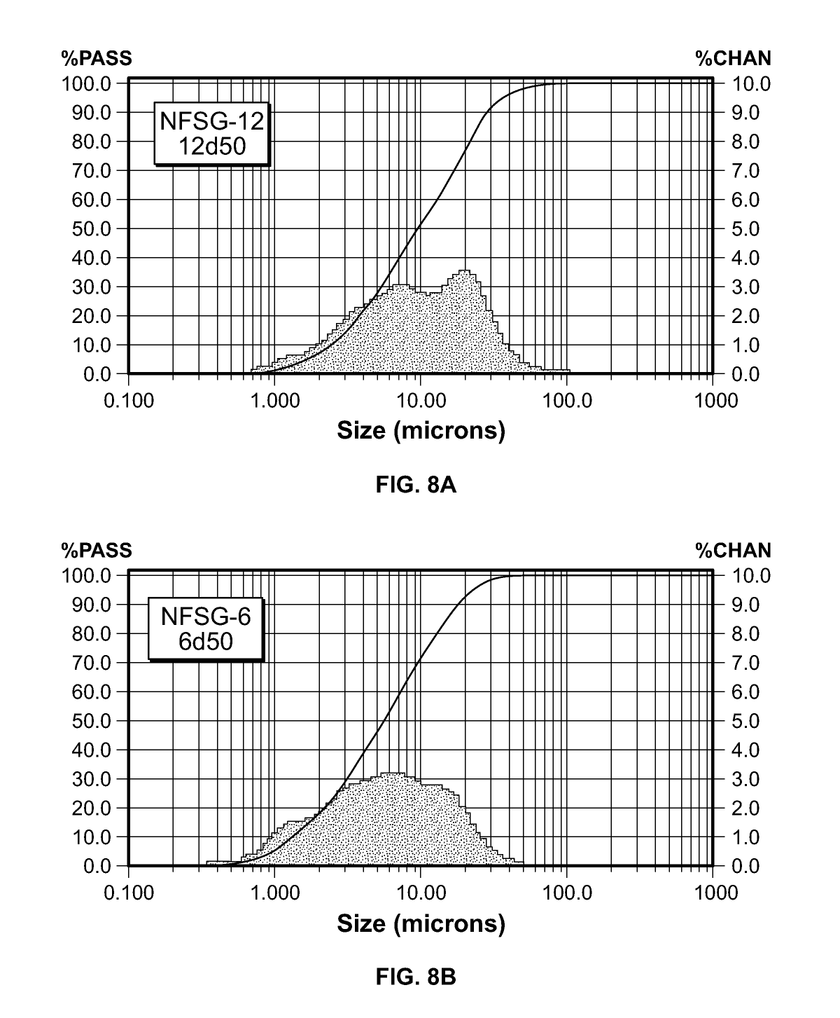

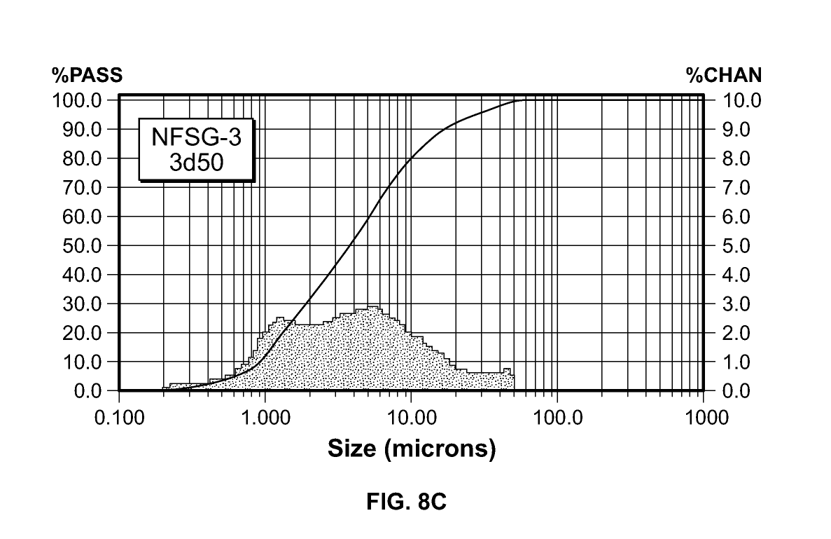

In terms of cementitious reactivity, pozzolan products with median sizes in the 6-12 μm range can be comparable with blast furnace slag; or median sizes in the 3-4 μm range that compare with silica fume. Typically, the particle size for ultrafine NFS powder is a nominal 12 μm median size (12d50); a nominal 8 μm median size (8d50); a nominal 6 μm median size (6d50); or a nominal 3 μm median size (3d50). Typically, the ultrafine NFS powder has a particle size in the range of about 3 μm to about 15 μm, preferably about 5 μm to about 12 μm, and more preferably about 5 μm to about 8 μm as measured by laser interferometer. Alternatively, the ultrafine NFS powder can be measured in terms of Blaine specific surface area units (cm²/g). Typically, the ultrafine NFS powder particle size as measured by Blaine units is about 3000 to about 11000, preferably it is about 3500 to about 9500, and more preferably about 4000 to about 8300. FIGS. 4A-4C illustrate the particle size distribution for air-cooled NFS as determined by laser interferometer as shown for three samples. NFS-12 has a d95% of about 25.6 μm (4088 Blaine units); NFS-6 has a d95% of about 12.1 μm (5650 Blaine); and NFS-3 has a d95% of about 6.6 μm (8236 Blaine). NFS-8 has a d95% of about 22 μm and a d50% of about 8 μm. FIGS. 8A-C illustrate the typical particle size distribution for granulated NFS as determined by laser interferometer as shown for three samples. NFSG-12 has a d95% of about 37.4 μm (4103 Blaine); NFSG-6 has a d95% of about 23.6 μm (5781 Blaine); and NFSG-3 has a d95% of about 15 μm (7606 Blaine).

The ultrafine NFS powder can be combined with or incorporated within cements or pozzolanic activators in proportions selected to achieve a desired rate of strength development for the intended application in a cementitious binder product, for use in applications such as mortars, grouts, concretes, backfill, and the like. Any cement or pozzolanic activator can be used to achieve depending upon the desired application. Typically, the cement includes, but is not limited to, Portland cement, high alumina cement, gypsum cement, or magnesium cements. Preferably, the cement is Portland cement. Pozzolanic activators include, but are not limited to, quicklime, hydrated lime, lime kiln dust, cement kiln dust, and the like. The invention encompasses mixtures of cements, mixtures of pozzolanic activators, and mixtures of cements and pozzolanic activators. When using cement, the ratio of ultrafine NFS powder to cement is about 90:10 to about 50:50 by weight, alternatively it can be from about 80:20 to about 60:40, or about 70:30. Alternatively, the ratio of ultrafine NFS powder to cement may individually be about 90:10; 80:20; 70:30; 60:40; or 50:50 by weight. Alternatively, the NFS can be inter-ground with the Portland cement either in the form of crushed clinker or powder to further enhance reactivity.

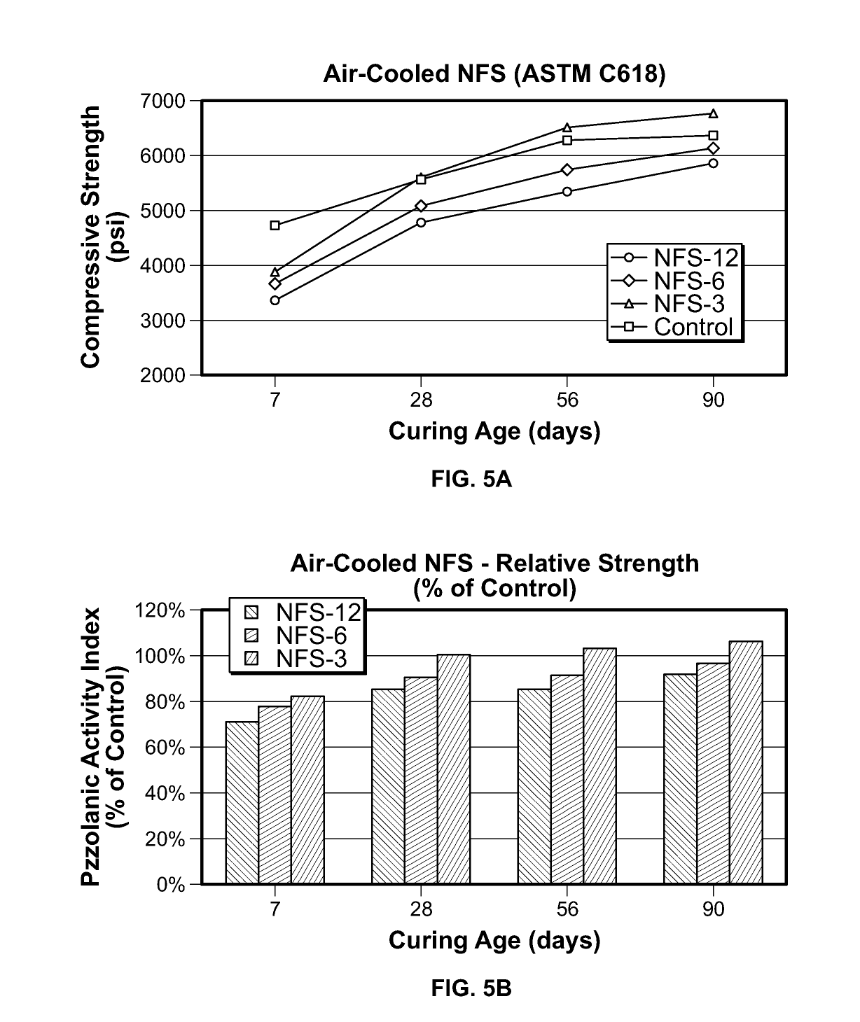

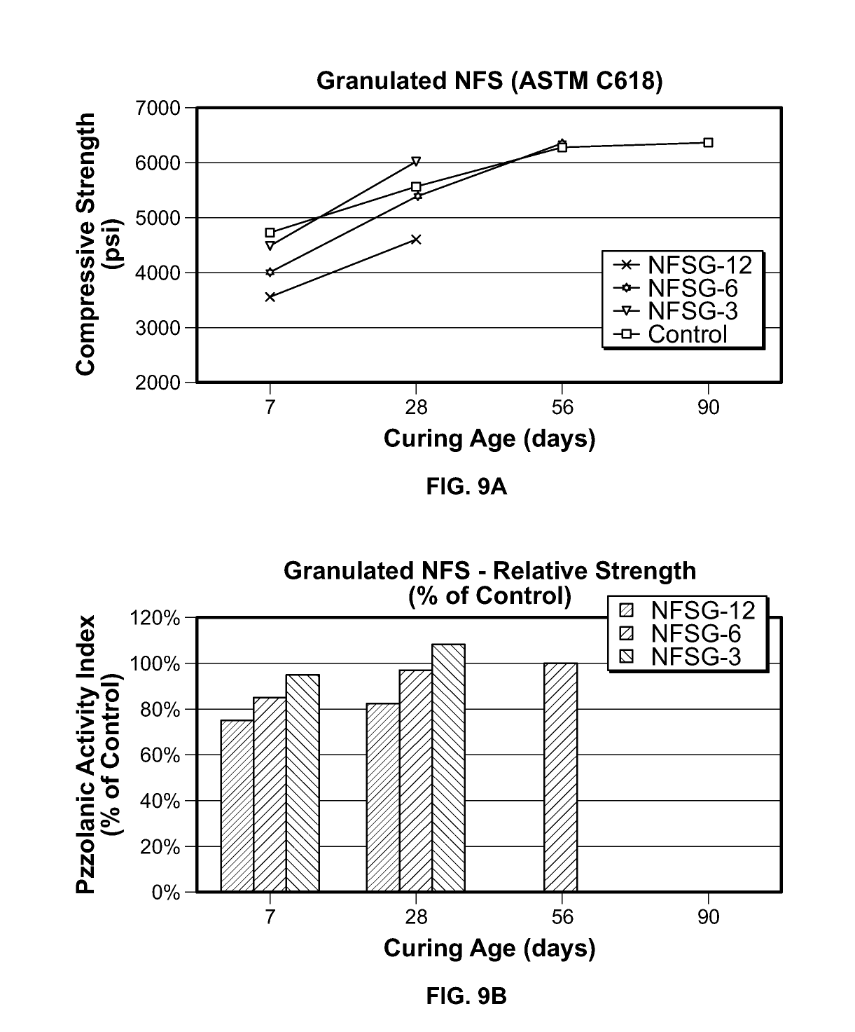

Materials containing the ultrafine NFS powder of the invention have strengths comparable to materials without the ultrafine NFS powder and in some cases, surpassed the control material after 56 or 90 days. One example of such materials is a mortar. Mortars where about 20% of the cement was replaced with the ultrafine NFS powder of the invention demonstrated strengths comparable to mortars without the ultrafine NFS powder (the control). In particular, the mortars having about 20% cement replacement had in excess of 75% of the control strength after 7 or 28 days of curing. Examples of these mortars having about 20% cement replacement with the ultrafine NFS powders of the invention have compressive strength (psi) of about 3000 psi to about 4500 psi at 7 days of curing; about 4500 psi to about 6000 psi at 28 days; about 5200 psi to about 6600 psi at 56 days; and 5800 psi to about 6900 psi at 90 days. FIGS. 5A and 9A graphically illustrate these results. The strength of the mortar was determined using the standardized ASTM C618 testing protocol.

Another method of measuring the strength of the materials made using the ultrafine NFS powder of the invention is to compare these materials to a control and measuring the pozzolanic activity index as a percent of the control. In one example, mortars where about 20% of the cement was replaced with the ultrafine NFS powder of the invention demonstrated strengths comparable to mortars without the ultrafine NFS powder (the control). In particular, the mortars having about 20% cement replacement demonstrated about 70% to 85% pozzolanic activity index of the control at 7 days; about 85% to about 100% at 28 days; about 85% to about 105% at 56 days; and about 90% to about 110% pozzolanic activity index of the control at 90 days. FIGS. 5B and 9B graphically illustrate these results.

In addition, selected chemical components can be added to further enhance the properties of the cementitious product. Examples of these additional components include, but are not limited to, cement accelerators and water-reducing agents. Cement accelerators include, but are not limited to, calcium chloride, calcium nitrate, or sodium nitrate. Water-reducing agents include, but are not limited to, lignosulfonates, naphthalene sulfonates, or melamine sulfonates. The cementitious products may contain one or more of the cement accelerators and/or water-reducing agents. A skilled artisan would know in what proportions to add these additional chemical components depending upon the desired characteristics of the cementitious product.

The chemical additive may be a compound included in the binder that enhances the chemical reactions between the non-ferrous slag and cement, such as Portland cement. Typically, this chemical additive is at least one compound that increases the pH, which may yield an alkaline solution with an elevated pH when dissolved in water. Those of skill in the art with little or no experimentation can easily determine suitable pH increasing compounds. Typical pH increasing compounds include, but are not limited to, sodium, potassium, calcium salts, or mixtures therefore. Such pH increasing compounds include, but are not limited to, at least one of anhydrous sodium carbonate (Na₂CO₃, soda ash), hydrated sodium carbonate (Na₂CO₃.nH₂O, washing soda), sodium bicarbonate (NaHCO₃, baking soda), sodium hydroxide (NaOH, caustic soda), sodium metasilicate (Na₂SiO₃, water glass), anhydrous potassium carbonate (K₂CO₃), hydrated potassium carbonate (K₂CO₃.nH₂O), potassium bicarbonate (KHCO₃), potassium hydroxide (KOH), potassium metasilicate (K₂SiO₃), calcium oxide (CaO, lime), or calcium hydroxide (Ca(OH)₂, hydrated lime).

The amount of pH increasing compound should be sufficient to raise the pH of the composition to the desired level. Such increase typically increases the rate of strength development and the ultimate strength of the compositions when such compositions are employed to bind or cement typical mine backfill or grout mixtures. Typically, the amount of additives present in the binder is about 1% to about 10% by weight of the binder composition and preferably, the amount is about 3% to about 5% by weight.

There are significant technical and performance findings observed for the enhanced NFS products of the invention. For example, the significant technical and performance findings include: (a) low water demand; (b) no negative effects on set times; and (c) marked improvements in pozzolanic reactivity and early strength development. The NFS is a low water demand pozzolan, similar to many fly ashes, which permits higher cement replacement levels.

The method encompassed by the invention efficiently processes the waste non-ferrous smelter slag (NFS) into value added pozzolan products. These products can be effectively incorporated into binder compositions such as those used by the mining industry in consolidated backfill.

Also, in one embodiment, the aggregate component of hydraulic backfill may be graded sand. This graded sand may be recovered from flotation tailings (known as classified tails or tailings), local quarried alluvial sand, or overburden, which is recovered from site preparation. This aggregate component may be mixed in a processing plant with a predetermined amount of binder to provide a desired compressive strength for backfill underground. For example, 10 parts of sand (the aggregate component) are mixed with one part of binder (e.g., 90:10 GGBFS:PC). In another example, 30 parts of sand are combined with one part of binder.

A further innovation of the present invention is that the non-ferrous slag may be pulverized into sand-sized gradation which may be used to replace some or all of the aggregate material used in the backfill. The non-ferrous slag may be either an air cooled, granulated, or pelletized form. This is particularly advantageous for the replacement of alluvial sand in mines that use this material, and results in significant cost savings for the backfill operation and conservation of mineral resources. The NFS sand may be used to supplement classified flotation tailings in certain mine locations.

In addition to cost savings, the use of non-ferrous slag sand in the backfill compositions also introduces desirable chemical compatibility with the cementitious binder that is not found in alluvial sand. It will be recognized that the sand-sized particles of the non-ferrous slat will contain the same mineralogical components as the pozzolanic material processed by ultrafine grinding for use in the binder. This means that the surface of the sand-sized particles will be reactive to some extent towards the alkaline binder system, the result being that the chemical bond between the binder and the aggregate particles will be enhanced and stronger than with alluvial sand. This benefit will facilitate the design of stronger backfill for a given binder content; or alternatively, reduction of the binder required for a target backfill strength. The latter option will introduce further significant cost savings into the backfill operation of the mine.

The air-cooled non-ferrous slag may be processed into a sand sized gradation by a variety of comminution techniques including, but not limited to, mechanical devices such as a jaw crusher, a hammer mill, a compression roll crusher, or a ball mill, or a combination thereof. An alternative and more energy-efficient method for producing sand-sized gradation from non-ferrous slag is to rapidly quench molten slag discharge from a smelter by either (a) water granulation, or (b) air pelletization.

The method of the invention comprises: (1) pretreating NFS from a smelter into a coarse sand consistency to obtain a pre-processed NFS; (2) ultrafine grinding of the pre-processed NFS to obtain an ultrafine NFS powder; and (3) blending or intergrinding the ultrafine NFS powder with a cement to obtain a cementitious product. Optionally, the method may encompass an additional step of adding chemical additives to the ultrafine NFS powder which is then added to or blended with the cement. Such chemical additives may be added either in dry form or pre-dissolved in a suitable solvent (such as water).

The pretreating step converts NFS from a smelter into particles having a coarse sand consistency. Typically, this step can be performed by crushing, air-cooling, water granulation, or pelletization. Preferably, the step is carried out using water granulation or pelletization, and more preferably by pelletization.

The ultrafine grinding step converts the pre-processed NFS into an ultrafine NFS powder having a particle size and intends to expose a fresh internal surface, thereby releasing the latent reactivity present in the glassy fraction of the non-ferrous slag. Typically, the particle size in this step is about nominal 12 μm median size (12d50); about nominal 8 μm median size (8d50); about nominal 6 μm median size (6d50); or about nominal 3 μm median size (3d50).

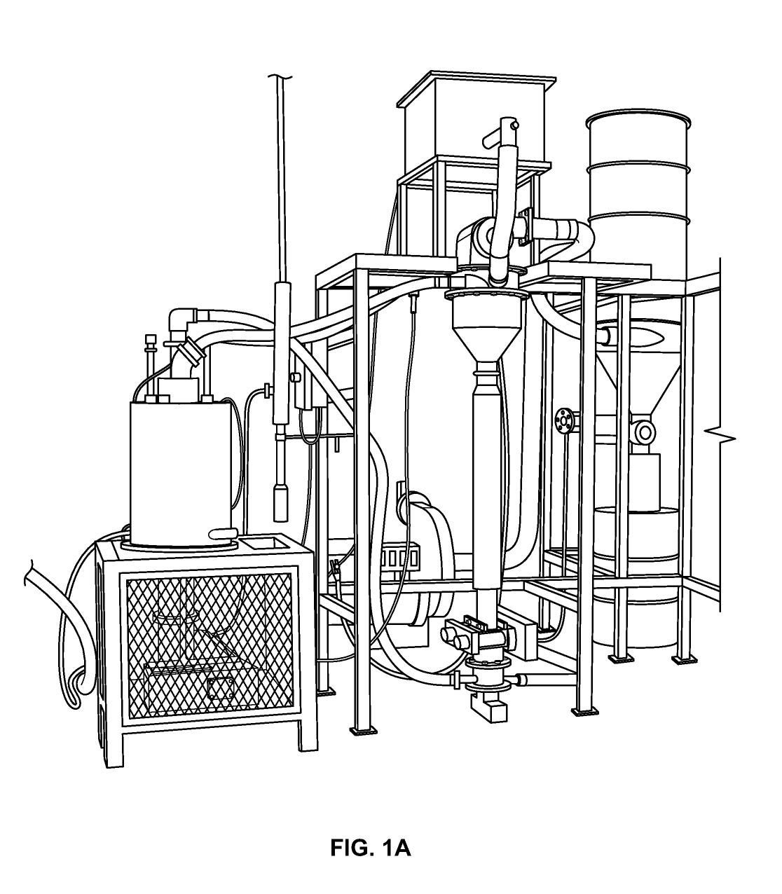

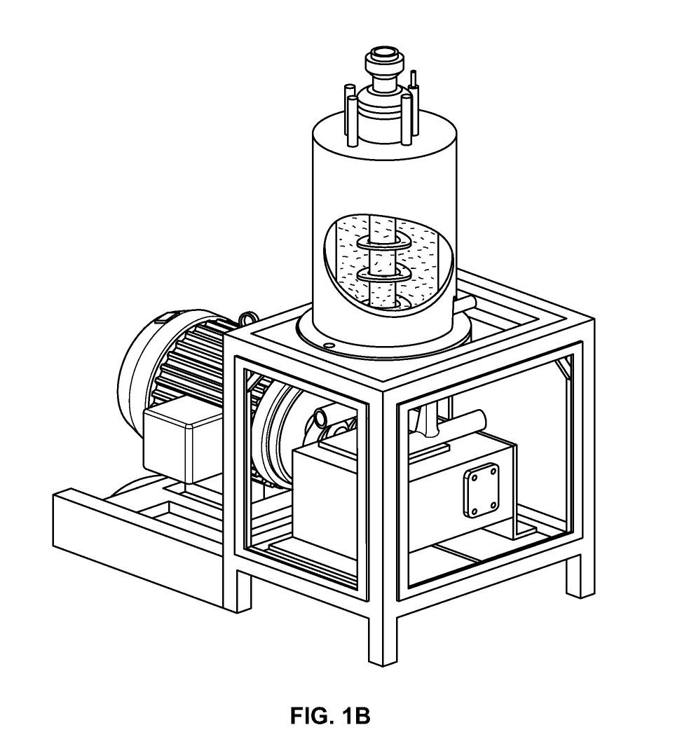

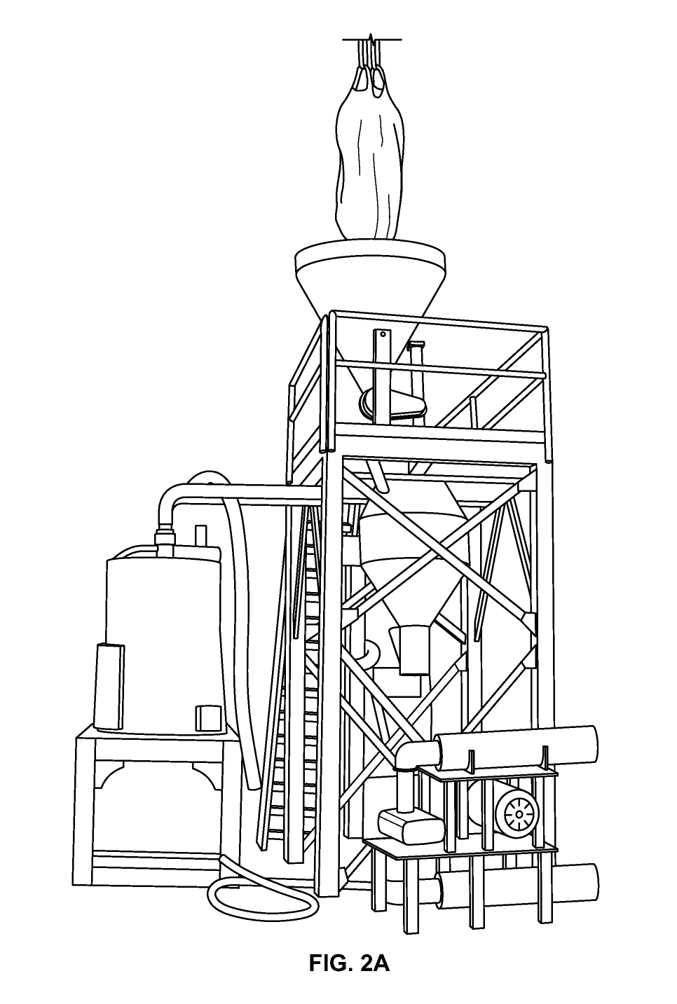

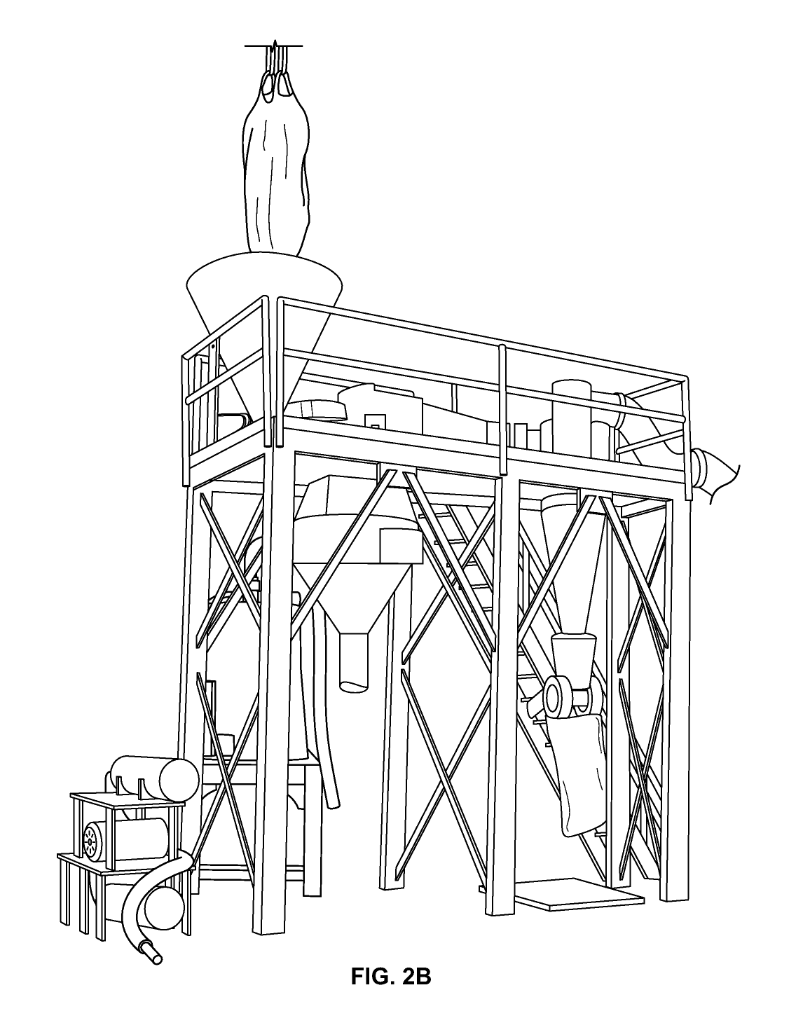

The preferred technology used in the fine grinding step of the process is based on a stirred media mill in circuit with a high efficiency air classifier. FIGS. 1A-B and 2A-B illustrate such commercially available technology. However, other types of apparatus may also be used such as those disclosed in U.S. Patent Application No. 2011/0226878, hereby incorporated by reference. Further, a grinding system can be configured to produce a variety of NFS product grades with tailored particle size distributions.

The blending step combines the ultrafine NFS powder of the second step with cements to yield a cementitious product. The ultrafine NFS powder can be combined or incorporated within with cements in proportions selected to achieve a desired rate of strength development for the intended application in a cementitious product, such as a binder. Any cement can be used to achieve depending upon the desired application. Typically, the cement includes, but is not limited to, Portland cement, quicklime, hydrated lime, and the like. Preferably, the cement is Portland cement. When using cement, the ratio of ultrafine NFS powder to cement is about 90:10 to about 50:50 by weight, alternatively it can be from about 80:20 to about 60:40, or about 70:30. Alternatively, the ratio of ultrafine NFS powder to cement may individually be about 90:10; 80:20; 70:30; 60:40; or 50:50 by weight. Alternatively, the NFS can be inter-ground with the cement either in the form of crushed clinker or powder to further enhance reactivity.

In addition, at least one selected chemical component can be added to further enhance the properties of the cementitious product. Examples of these additional components include, but are not limited to, cement accelerators, water-reducing agents, binders, or pH increasing compounds. Cement accelerators include, but are not limited to, calcium chloride, calcium nitrate, or sodium nitrate. Water-reducing agents include, but are not limited to, lignosulfonates, naphthalene sulfonates, or melamine sulfonates. pH increasing compounds include, but are not limited to, those discussed above. A skilled artisan would know in what proportions to add these additional chemical components depending upon the desired characteristics of the cementitious product. Also, such additional components may be intimately blended in the desired proportions with the non-ferrous slag and cement powders, or pre-dissolved in the desired proportions in a suitable solvent (such as water) employed for hydration of the binders.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### EXAMPLES

### Example 1

### Grinding Using Air-Cooled System

The commonly encountered form of NFS is in large lumps (>50 cm), as it is handled and produced on site. In the first step of the method, this NFS was crushed into a sand prior fine grinding the sand-like NFS. Subsequently, the sand-like NFS was ground using a stirred media mill in circuit with a high efficiency air classifier system into a fine powder. Typical examples of the size and energy consumption for the fine-powder obtained using an air-cooled NFS were: 12 μm d50=69 kW·h/ton; 8 μm d50=129 kW·h/ton; and 3 μm d50=240 kW·h/ton. The chemical and mineralogical composition of the fine powders prepared using this system is illustrated in FIG. 3. The element oxide composition of the surface of bulk raw NFS sample was SiO₂ 37.4% (by weight of the glass); Al₂O₃ 3.2%; Fe₂O₃ 57.9%; MgO 1.36%; CaO 1.27%; Na₂O 0.53%; K₂O 0.69%; carbon 0.03%; sulfur 1.01%; and LOI −4.07%. The physical properties of the powders prepared using this system are illustrated in FIG. 4. NFS-12 had a d95% of 25.8 μm and a Blaine reading of 4088 cm²/g; NFS-6 had a d95% of 12.1 μm and a Blaine reading of 5650 cm²/g; and NFS-3 had a d95% of 6.6 μm and a Blaine reading of 8236 cm²/g.

### Example 2

### Mortar Strength Using the NFS of Example 1

Using the ultrafine NFS powders of Example 1, binders were prepared with a range of Portland cement-to-NFS ratios as required under ASTM C618. These binders were tested in mortars by a standardized testing protocol specified for pozzolanic materials (ASTM C618), using 20% Portland cement replacement by the NFS in silica sand mortars. FIGS. 5A and 5B illustrate the relationship between the compressive strength and pozzolanic activity index for these mortars. After 7 and 28 days curing, the mortars made using 20% replacement with the NFS of the invention had strengths of approximately 75% of the control (no replacement with NFS). The pozzolanic activity index (as a percent of the control) for NFS-12 was 71% after 7 days and 86% after 28 days; for NFS-6 it was 78% after 7 days and 91% after 28 days; and for NFS-3 it was 82% after 7 days and 101 after 28 days.

It was found that pozzolanic reactivity increased with NFS grain fineness. This demonstrated that fine-ground, air-cooled NFS was a reactive pozzolan, and was ASTM C618 compliant at the 6d50 grade with good long-term strength development. The NFS is a low water demand pozzolan, similar to many fly ashes, which permits higher cement replacement levels.

### Example 3

### Grinding Using Granulation

The purpose of granulation was twofold: first, to increase the proportion of the reactive glassy silicate phase; and second, to create sand-sized particles that were ideal as feed material for the fine grinding mill. This strategy significantly simplified and reduced the energy consumption of pre-processing the slag prior to fine grinding.

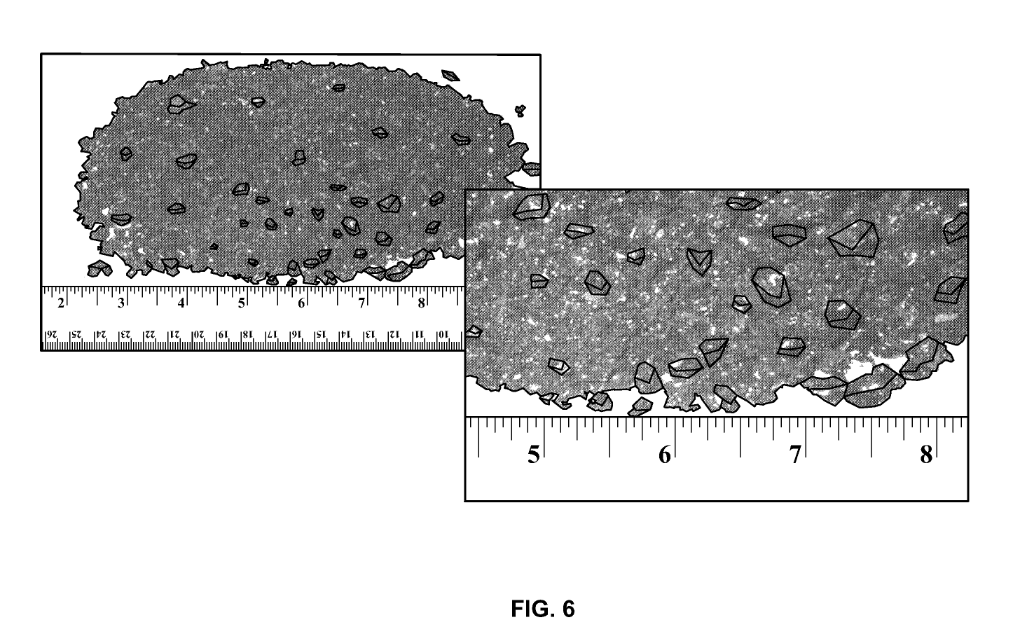

The concept was tested in the lab. First, the as-received NFS was melted in a laboratory furnace at 1450° C. Subsequently, the molten slag was rapidly quenched in a large volume of water to produce a granulate with sand-sized particles. FIG. 6 illustrates the optical microscope images of this material. The mineralogy of the NFS granulate confirmed that the glass content has been significantly increased as shown in FIG. 7 and Table 1 below. The granulated NFS was ground in a lab ball mill to nominal 3 μm, 6 μm, and 12 μm median (d50) products as illustrated in FIG. 8. NFSG-12 had a d95% of 37.4 μm and a Blaine reading of 4103 cm²/g; NFS-6 had a d95% of 23.6 μm and a Blaine reading of 5781 cm²/g; and NFS-3 had a d95% of 15 μm and a Blaine reading of 7606 cm²/g.

### Example 4

### Mortar Strength Using the NFS of Example 3

Using the ultrafine NFS powders of Example 3, binders were prepared with a range of Portland cement-to-NFS ratios as required under ASTM C618. These binders were tested in mortars by a standardized testing protocol specified for pozzolanic materials (ASTM C618), using 20% Portland cement replacement by the NFS in silica sand mortars. FIGS. 9A and 9B illustrate the relationship between the compressive strength and pozzolanic activity index for these mortars. After 7 and 28 days curing, the mortars made using 20% replacement with the NFS of the invention had strengths of approximately 75% of the control (no replacement with NFS). The pozzolanic activity index (as a percent of the control) for NFS-12 was 75% after 7 days and 83% after 28 days; for NFS-6 it was 85% after 7 days and 97% after 28 days; and for NFS-3 it was 95% after 7 days and 108 after 28 days.

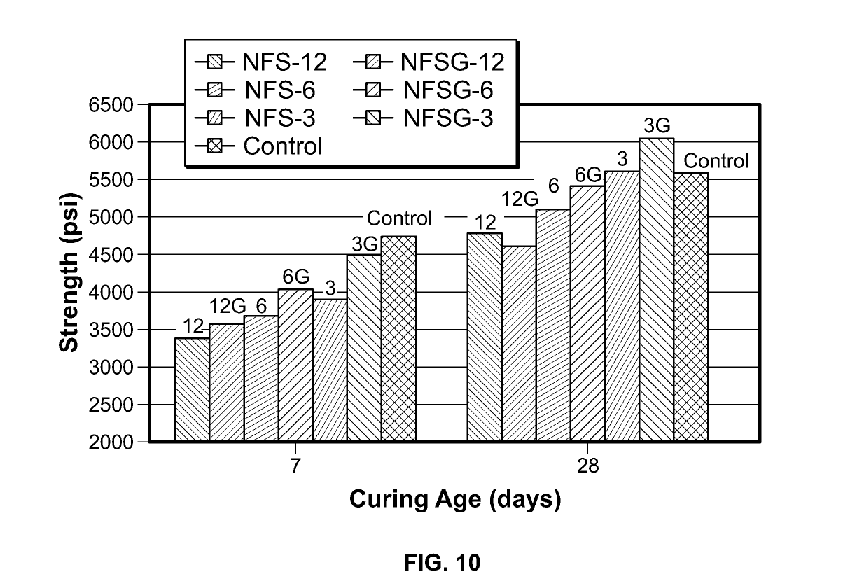

FIG. 10 illustrates the strength comparison between mortars made with air-cooled and granulated NFS, as illustrated in examples 2 and 4 above. The tests indicated that granulation was effective for increasing glass content and improving reactivity. Table 1 summarizes the flow and pozzolanic activity of the samples illustrated in FIG. 10.

FIG. 10 illustrates the strength comparison between mortars made with air-cooled and granulated NFS, as illustrated in examples 2 and 4 above. The tests indicated that granulation was effective for increasing glass content and improving reactivity. Table 1 summarizes the flow and pozzolanic activity of the samples illustrated in FIG. 10.

TABLE 1

| | | Pozzolanic Activity 28 d |
|---|---|---|
| Binder Product | Flow | (% of control) |
| Control | 85 | — |
| NFS-12 | 100 | 86 |
| NFS-6 | 102 | 91 |
| NFS-3 | 88 | 101 |
| NFSG-12 | 118 | 83 |
| NFSG-6 | 112 | 97 |
| NFSG-3 | 112 | 108 |

### Example 5

### Pelleted NFS

The intent of pelletization is similar to that of granulation. In other words, the intent is to increase the glass content of the NFS and reduce the particle size to eliminate need for a crushing step before the stirred media mill. The significant difference is that the process is substantially dry, so that there is no need for treatment and management of process water, a major advantage in this process.

### Example 6

### Test Protocol

The samples described in the figures were prepared as followed. A typical simulated backfill sample for testing was prepared by mixing components sufficient for 4″×8″ extended cylinders of prepared material (approximately 45 kg). A set of draining extended cylinders 4″×8″ were also prepared along with sand drainage beds with approximately 4″ sand layer. The samples were cast and placed in a sand bed for 24 hours, followed by curing at 100% RH at 21° C. Three cylinders were tested at 7, 14, 28, and 56 days.

A series of simulated backfill specimens were prepared in the manner described above. In particular, materials were prepared using alluvial sand, classified tailings, or synthetic sands with a binder comprised of ultrafine NFS powder and Portland cement combined in various ratios. When the samples were prepared with alluvial sand, the solid content by mass (Cw) was 74% and the binder content was 3% by weight. For the binder, the weight ratios of ultrafine NFS powder to Portland cement were 90:10; 80:20; 70:30; 60:40, and 50:50. Another example used classified tailings wherein the solids content by mass (Cw) was 68% and the binder content was 10% by weight. For the binder, the weight ratios of ultrafine NFS powder to Portland cement were 90:10; 80:20; 70:30; 60:40, and 50:50. Yet another example used synthetic NFS sand wherein the solid content by mass (Cw) was 78% and the binder content was 3% by weight. The weight ratios of ultrafine NFS powder to Portland cement were 80:20 and 70:30.

### Example 7

### Alluvial Sand Series

Using the method described in Example 6 a series of samples with alluvial sand were prepared and tested for compressive strength after curing for a determined period of time. Table 2 summarizes the results, PC=Portland cement; uNFS=ultrafine NFS powder; and GGBFS=ground granulated blast furnace slag. The w/cm ratio was about 11-12. The goal for backfill was to achieve a compressive strength of 50 psi.

TABLE 2
Alluvial Sand Series

| | | | Binder | | Compressive Strength (psi) | | | |
|---|---|---|---|---|---|---|---|---|
| Sam- | Sand | Binder | Cement | Cw | 7 | 14 | 28 | 56 |
| ple | type | Material | % | % | days | days | days | days |
| 1 | Alluvial | PC/uNFS | 3 | 74 | 9 | 11 | 15 | 15 |
| 2 | Alluvial | PC/uNFS | 3 | 74 | 16 | 19 | 21 | 25 |
| 3 | Alluvial | PC/uNFS | 3 | 74 | 14 | 20 | 26 | 34 |
| 4 | Alluvial | PC/uNFS | 3 | 74 | 18 | 21 | 29 | 35 |
| 5 | Alluvial | PC/uNFS | 6 | 74 | 22 | 35 | 42 | 61 |

### Example 9

### Classified Tailings Series

Using the method described in Example 6 a series of simulated backfill samples with classified tailings were prepared and tested for strength after curing for a determined period of time. Table 3 summarizes the results, PC=Portland cement; uNFS=ultrafine NFS powder. The w/cm ratio was about 5. The goal for backfill was to achieve a compressive strength of 50 psi.

TABLE 3
Classified Tailings Series

| | | | Binder | | Compressive Strength (psi) | | | |
|---|---|---|---|---|---|---|---|---|
| Sam- | Sand | Binder | Cement | Cw | 7 | 14 | 28 | 56 |
| ple | type | Material | % | % | days | days | days | days |
| 6 | Classified | PC/uNFS | 10 | 68 | 0 | 0 | 9 | na |
| | Tailings | | | | | | | |
| 7 | Classified | PC/uNFS | 10 | 68 | 9 | 12 | 13 | na |
| | Tailings | | | | | | | |
| 8 | Classified | PC/uNFS | 10 | 68 | 17 | 29 | 37 | na |
| | Tailings | | | | | | | |
| 9 | Classified | PC/uNFS | 10 | 68 | 28 | 38 | 95 | 110 |
| | Tailings | | | | | | | |
| 10 | Classified | PC/uNFS | 10 | 68 | 38 | 53 | 126 | 135 |
| | Tailings | | | | | | | |

### Example 10

### Volumetric Mix Design

Although batched by mass, concrete mix designs are done volumetrically. Conventionally, a mix is designed for one cubic meter of concrete. A high density aggregate such as ultrafine NFS powder requires a higher mass per unit volume. In this example, several samples were designed based on densities and volumes. Table 4 summarizes the results.

TABLE 4
Volumetric Design Mix

| | | Binder | Cw | | Slurry | Solid | Water |
|---|---|---|---|---|---|---|---|
| Aggregate | Sample | % | % | W:cm | Density | V % | V % |
| Classified | Control | 10 | 74 | 2.6 | 1.849 | 51.9 | 48 |
| Tailings | | | | | | | |
| Classified | 11 | 10 | 74 | 2.6 | 1.867 | 51.5 | 48.5 |
| Tailings | | | | | | | |
| Alluvial | Control | 3 | 74 | 8.7 | 1.875 | 51.2 | 48.7 |
| Sand | | | | | | | |
| Alluvial | 12 | 3 | 74 | 8.7 | 1.880 | 51.1 | 48.9 |
| Sand | | | | | | | |
| Slag Sand | Control | 3 | 74 | 8.7 | 2.123 | 44.8 | 55.2 |
| Slag Sand | 13 | 3 | 74 | 8.7 | 2.130 | 44.6 | 55.4 |
| Slag Sand | Control | 3 | 79 | 7 | 2.298 | 51.7 | 48.3 |
| Slag Sand | 14 | 3 | 79 | 7 | 2.307 | 51.6 | 48.4 |

### Example 11

### Non-Ferrous Slag Sand Series

Using the method described in Example 6 a series of simulated backfill samples with non-ferrous slag sand were prepared and tested for compressive strength after curing for a predetermined period of time. Table 5 summarizes the results, PC=Portland cement; uNFS=ultrafine NFS powder. The goal for backfill was to achieve a compressive strength of 50 psi.

TABLE 5
Non-Ferrous Slag Sand Series

| | | | Binder | | Strength (psi) | | | |
|---|---|---|---|---|---|---|---|---|
| Sam- | Sand | Binder | Cement | Cw | 7 | 14 | 28 | 56 |
| ple | type | Material | % | % | days | days | days | days |
| 15 | NFS sand | PC/uNFS | 3 | 78 | 0 | 12 | 18 | 21 |
| 16 | NFS sand | PC/uNFS | 3 | 78 | 6 | 12 | 15 | 19 |
| 17 | NFS sand | PC/uNFS | 6 | 78 | 12 | 23 | 30 | 50 |
| 18 | NFS sand | PC/uNFS | 6 | 78 | 14 | 31 | 45 | 159 |

### Example 12

### Enhanced Binder Composition Design Mixes Series

Using the method described in Example 6 a series of simulated backfill samples with enhanced binder (comprised of ultrafine NFS powder, cement, and a chemical enhancement additive) were prepared and tested for compressive strength after curing for a predetermined period of time. Table 6 summarizes the results uNFS=ultrafine NFS powder. The w/cm ratio was about 5.

TABLE 5
Enhanced Binder Series

| | | | Bind- | Enhance- | Compressive Strength (psi) | | | |
|---|---|---|---|---|---|---|---|---|
| Sam- | Sand | Binder | er wt | ment | 7 | 14 | 28 | 56 |
| ple | Type | Type | % | wt % | days | days | days | days |
| 19 | Clas- | uNFS70 | 10 | 2 | 33 | 48 | 83 | 107 |
| | sified | | | | | | | |
| | Tailings | | | | | | | |
| 20 | Clas- | uNFS70 | 10 | 4 | 51 | 84 | 122 | 154 |
| | sified | | | | | | | |
| | Tailings | | | | | | | |
| 21 | Clas- | uNFS60 | 10 | 4 | 79 | 100 | 173 | 215 |
| | sified | | | | | | | |
| | Tailings | | | | | | | |

1. An ultrafine non-ferrous slag (NFS) powder comprising non-ferrous slag having a median particle size of about 3μm to about 15 μm, wherein the particle size is sufficiently small to increase the proportion of the reactive glassy silicate phase in the non-ferrous slag.

2. The ultrafine non-ferrous slag powder according to claim 1, wherein the median particle size is about 5 μm to about 12 μm.

3. The ultrafine non-ferrous slag powder according to claim 1, wherein the glassy silicate phase has a SiO₂ surface area increase of 40% to 70% as compared to the bulk NFS that has not been pulverized to the median particle size of about 3 μm to about 15 μm.

4. The ultrafine non-ferrous slag powder according to claim 1, wherein the glassy silicate phase has a sulfur surface area increase of 180% to 270% as compared to the bulk NFS that has not been pulverized to the median particle size of about 3 μm to about 15 μm.

5. The ultrafine non-ferrous slag powder according to claim 1, wherein the glassy silicate phase has SiO₂ in an amount of about 25% to about 70% by weight of the glassy silicate as determined by the surface area.

6. The ultrafine non-ferrous slag powder according to claim 1, wherein the glassy silicate phase has sulfur in an amount of about 0.5% to about 5% by weight of the glassy silicate as determined by the surface area.

7. The ultrafine non-ferrous slag powder according to claim 1 having a composition of about 65% to about 70% by weight of fayalite, about 5% magnetite, and about 25-30% by weight of glass.

8. A cementitious composition comprising the ultrafine NFS powder according to claim 1 and at least one cement.

9. The cementitious composition according to claim 8, wherein the weight ratio of ultrafine NFS powder to cement is about 90:10 to 50:50.

10. The cementitious composition according to claim 8 having a compressive strength of about 3000 psi to about 4500 psi after 7 days of curing as determined by ASTM C618 protocol.

11. The cementitious composition according to claim 8 having a pozzolanic activity index of about 70% to about 85% relative a control having no ultrafine NFS powder after 7 days of curing.

12. The cementitious composition according to claim 8 further comprising at least one cement accelerator, water-reducing agent, binder, or pH increasing compound.

13. The cementitious composition according to claim 12, wherein the cement accelerator is at least one calcium chloride, calcium nitrate, or sodium nitrate.

14. The cementitious composition according to claim 12, wherein the water-reducing agent is at least one lignosulfonate, naphthalene sulfonate, or melamine sulfonate.

15. The cementitious composition according to claim 12, wherein the pH increasing compound is anhydrous sodium carbonate, hydrated sodium carbonate, sodium bicarbonate, sodium hydroxide, sodium metasilicate, anhydrous potassium carbonate, hydrated potassium carbonate, potassium bicarbonate, potassium hydroxide, potassium metasilicate, calcium oxide, or calcium hydroxide.

16. The cementitious composition according to claim 15, wherein the pH increasing compound is present in an amount of about 1% to about 10% by weight of the binder.

17. A process for making an ultrafine non-ferrous slag (NFS) powder comprising: (1) pretreating bulk NFS from a smelter into a coarse sand consistency to obtain a pre-processed NFS; and (2) ultrafine grinding of the pre-processed NFS to obtain an ultrafine NFS powder of a determined particle size, wherein the particle size is sufficiently small to increase the proportion of the reactive glassy silicate phase in the NFS.

18. The process according to claim 17, wherein the ultrafine non-ferrous slag powder has a median particle size of about 3 μm to about 15 μm.

19. The process according to claim 17, wherein the ultrafine non-ferrous slag powder has a median particle size of about 5 μm to about 12 μm.

20. The process according to claim 17, wherein the ultrafine non-ferrous slag powder has a glassy silicate phase having SiO₂ with a surface area increase of 40% to 70% as compared to the bulk NFS.

21. The process according to claim 16, wherein the ultrafine non-ferrous slag powder has a glassy silicate phase having sulfur with a surface area increase of 180% to 270% as compared to the bulk NFS.
